(19) United States
(12) Patent Application Publication
(10) Pub. No.: US 2018/0134397 A1
(43) Pub. Date: May 17, 2018

(54) TURBO-GENERATOR BASED BLEED AIR SYSTEM

(71) Applicant: Hamilton Sundstrand Corporation, Windsor Locks, CT (US)

(72) Inventors: Richard A. Himmelmann, Beloit, WI (US); Stephen E. Tongue, Hampden, MA (US)

(21) Appl. No.: 15/351,015

(22) Filed: Nov. 14, 2016

(51) Int. Cl. B64D 13/08; F02C 6/08; F02C 9/18; B64D 15/04

(52) U.S. Cl. CPC B64D 13/08; F02C 6/08; B64D 2013/0644; B64D 15/04; F02C 9/18

(57) ABSTRACT

An engine bleed air system providing air to an aircraft system includes a port for extracting high pressure bleed air from an engine and a turbo-generator having a turbine and a generator. The generator is driven by rotation of the turbine. A bleed passage fluidly couples the port and an inlet of the turbo-generator. An outlet passage fluidly coupling an outlet of the turbo-generator and the aircraft system.

### BACKGROUND

This application relates to an aircraft, and more particularly, to a bleed air system for supplying air to one or more aircraft systems including an environmental control system.

Commercial aircrafts or jetliners typically employ an environmental control system to pressurize a passenger cabin of the aircraft and/or thermal anti-icing systems to provide heated air for anti-icing applications. Air supply to these systems is typically provided by bleed air extracted from or provided by a compressor of an aircraft engine.

To meet pressure and/or temperature demands of the various aircraft systems, bleed air is often extracted from a high stage of a low-pressure compressor of the aircraft engine. For example, bleed air is often extracted from an eighth stage compressor of an aircraft engine. The pressurized bleed air is then often cooled via a precooler and a pressure regulating valve prior to providing the bleed air to a system of the aircraft (e.g., environmental control system). Thus, a portion of the energy spent by the engine to produce the bleed air is wasted when cooling the bleed air via the precooler and reducing the pressure of the bleed air at the pressure regulating valve. This reduction in temperature and pressure dissipates the energy imparted to the bleed air by the engine without recovering it. This reduction in the efficiency of the bleed air system causes the engine to burn more fuel, thereby reducing the aircraft's overall fuel efficiency.

### SUMMARY

Disclosed herein is an engine bleed air system providing air to an aircraft system includes a port for extracting high pressure bleed air from an engine and a turbo-generator having a turbine and a generator. The generator is driven by rotation of the turbine. A bleed passage fluidly couples the port and an inlet of the turbo-generator. An outlet passage fluidly coupling an outlet of the turbo-generator and the aircraft system

Also disclosed herein is a method of operating a bleed air system of an aircraft includes drawing bleed air from an engine, extracting energy from the bleed air in a turbo-generator, and providing the bleed air to an aircraft system.

### BRIEF DESCRIPTION OF THE DRAWINGS

The following descriptions should not be considered limiting in any way. With reference to the accompanying drawings, like elements are numbered alike:

FIG. 1 is an example of an aircraft having one or more engines;

FIG. 2 is a cross-sectional diagram of a gas turbine engine of an aircraft according to one embodiment;

FIG. 3 is a schematic of a bleed air system for use with an aircraft engine according to one embodiment;

FIG. 4 is a schematic of another bleed air system for use with an aircraft engine according to one embodiment; and

FIG. 5 is a cross-sectional diagram of an example of a turbo-generator of the bleed air system according to an embodiment.

### DETAILED DESCRIPTION

A detailed description of one or more embodiments of the disclosed system is presented herein by way of exemplification and not limitation with reference to the Figures. It is to be understood that other embodiments may be utilized and changes may be made without departing from the scope of the present disclosure.

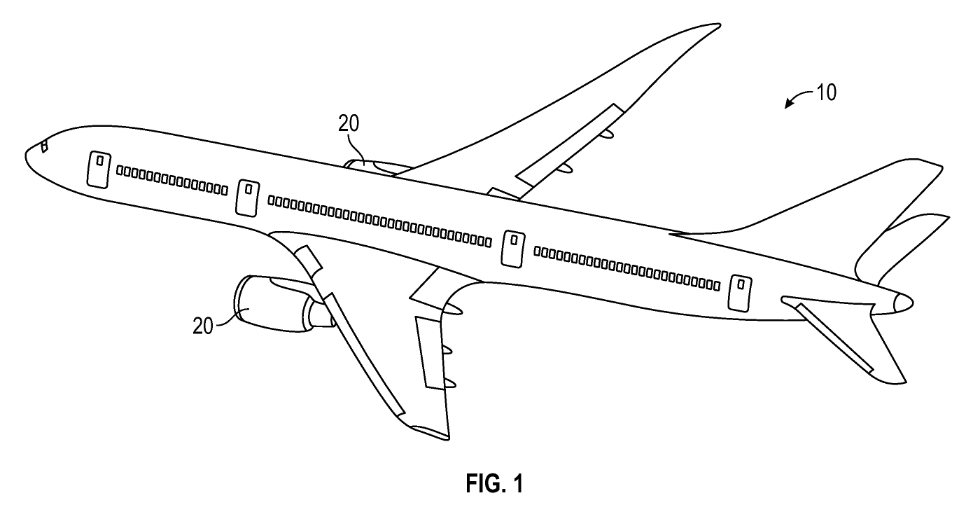

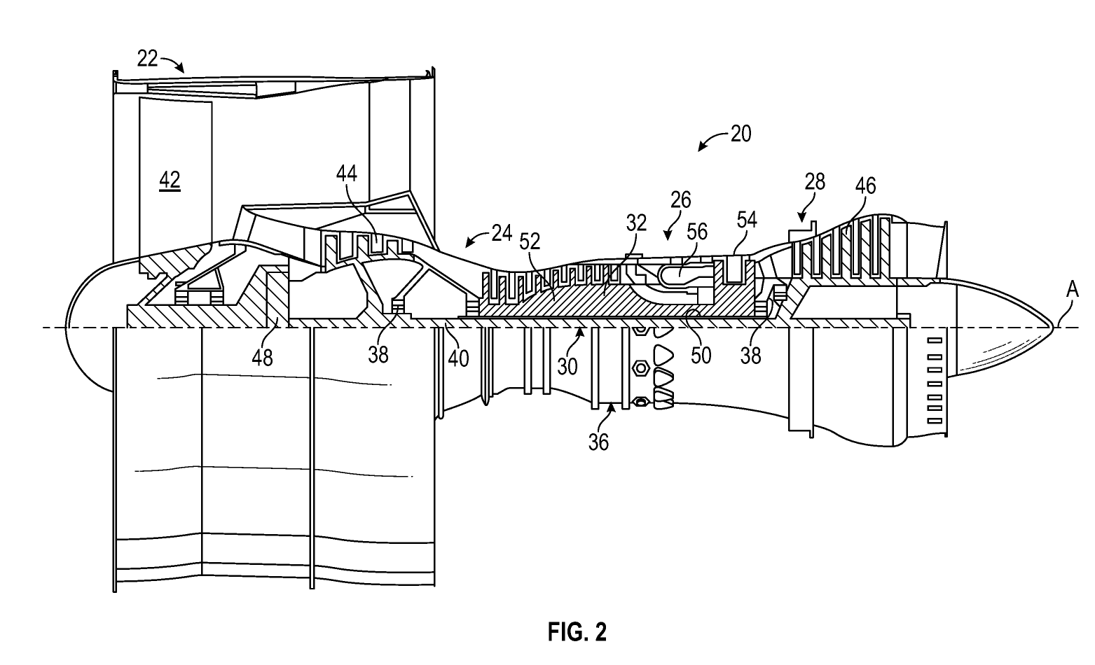

FIG. 1 illustrates an example of a commercial aircraft 10 having aircraft engines 20 that may embody aspects of the teachings of this disclosure. With reference to FIG. 2, an example of a gas turbine engine 20 configured for use in the aircraft 10 is illustrated schematically. The gas turbine engine 20 disclosed herein is a two-spool turbofan that generally incorporates a fan section 22, a compressor section 24, a combustor section 26 and a turbine section 28. Alternative engines might include an augmenter section (not shown) among other systems or features. The fan section 22 drives air along a bypass flow path while the compressor section 24 drives air along a core flow path for compression and communication into the combustor section 26 and then expansion through the turbine section 28. Although depicted as a turbofan gas turbine engine 20 in the disclosed non-limiting embodiment, it should be understood that the concepts described herein are not limited to use with turbofans as the teachings may be applied to other types of turbine engines, such as three-spool architectures for example.

The engine 20 generally includes a low spool 30 and a high spool 32 mounted for rotation about an engine central longitudinal axis A relative to an engine static structure 36 via several bearing systems 38. It should be understood that various bearing systems 38 at various locations may alternatively or additionally be provided.

The low spool 30 generally includes an inner shaft 40 that interconnects a fan 42, a low pressure compressor 44, and a low pressure turbine 46. The inner shaft 40 may be connected to the fan 42 directly or through a geared architecture 48 to drive the fan 42 at a different, typically lower, speed than the low spool 30. The high spool 32 includes an outer shaft 50 that interconnects a high pressure compressor 52 and a high pressure turbine 54. A combustor 56 is arranged between the high pressure compressor 52 and the high pressure turbine 54. The inner shaft 40 and the outer shaft 50 are concentric and rotate about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 54, 46 rotationally drive the respective low spool 30 and high spool 32 in response to the expansion.

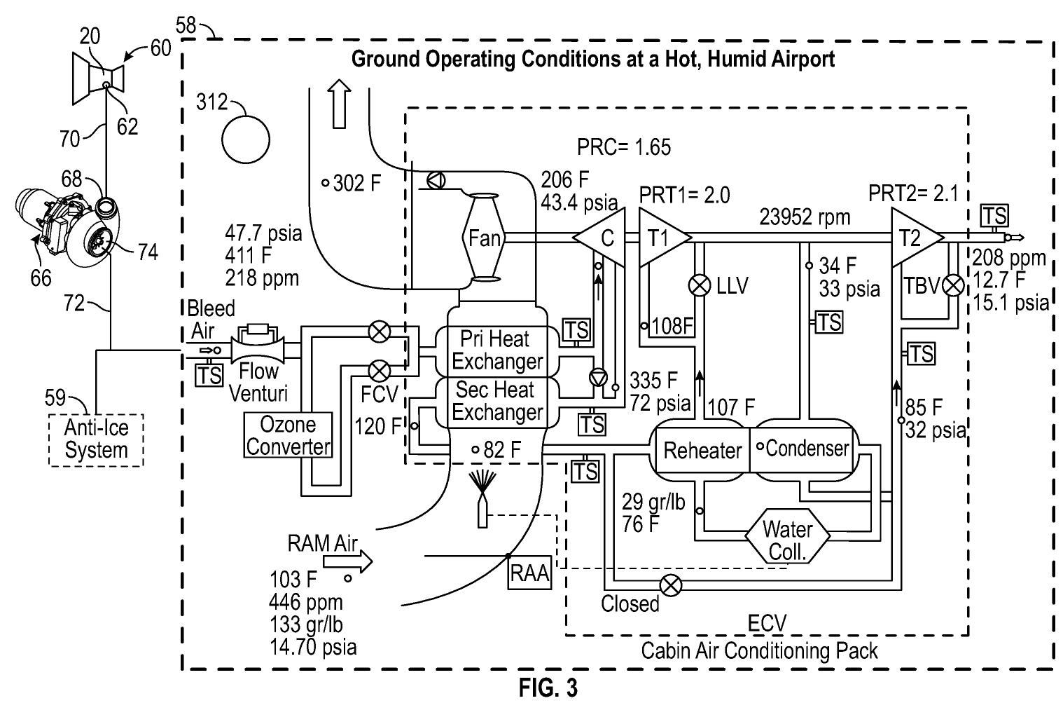

Referring now to FIG. 3, each engine 20 of the aircraft 10 may employ a dedicated bleed air system 60, or the plurality of engines 20 may employ a common bleed air system 60. The bleed air system 60 provides compressed or pressurized air to one or more aircraft systems such as, for example, an environmental control system, illustrated schematically at 58, to pressurize the cabin of an aircraft 10. Alternatively, or in addition, the bleed air may be used for anti-icing or deicing, heating or cooling, and/or operating pneumatic equipment, as illustrated schematically at 59.

The bleed air system 60 includes at least one port 62 for extracting air at various stages of the engine the engine 20. In the illustrated, non-limiting embodiment, of FIG. 3, the system 60 includes one or more ports 62 configured to bleed high pressure air from a portion of the high pressure spool 32, such as the high pressure compressor 52 for example. In such embodiments, the air drawn from the port 62 may have a maximum temperature of about 1200° F. and a maximum pressure of about 300 psia.

The bleed air system 60 additionally includes a turbo-generator 66. An inlet 68 of the turbo-generator 66 is arranged in fluid communication with the first port 62 via a first bleed passage 70. An outlet passage 72 extends from an outlet 74 of the turbo-generator 66 to one or more aircraft systems 58, 59.

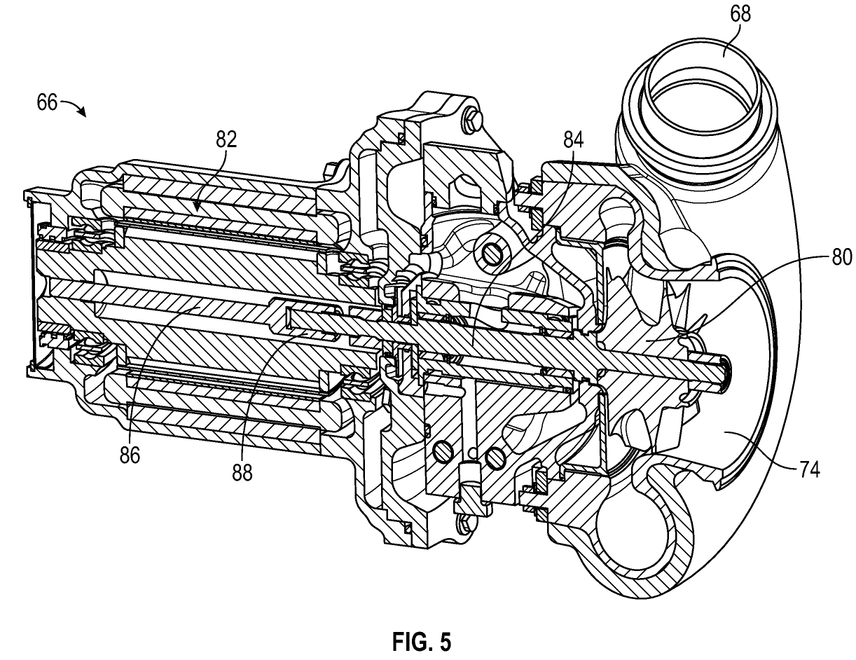

An example of a turbo-generator 66 for use in the bleed air system 60 is illustrated in more detail in FIG. 5. The turbo-generator 66 includes a turbine 80 that directly drives an electric generator 82. In the illustrated, non-limiting embodiment, the turbine 80 is mounted on a shaft 84 and the electric generator 82 includes a shaft 86. A coupler 88, separate from or integrally formed with one of the shafts 84, 86, operably couples the turbine shaft 84 and the generator shaft 86 such that rotation of the turbine shaft 84 is transmitted to the generator shaft 86. Rotation of the turbine 80, driven by the flow of bleed air provided at an inlet opening 68, drives rotation of the generator shaft 86. Accordingly, rotation of the turbine 80 extracts energy from the bleed air and converts it into electrical energy via the generator 82. The energy created at the generator 82 may be stored, or alternatively, may be sent to an aircraft bus (not shown) where it is then supplied to one or more electrical loads of the aircraft 10.

The operational parameters of the turbo-generator 66 may be varied to achieve a desired reduction in not only pressure, but also temperature of the bleed air. For example, if the temperature of the bleed air requires cooling, the current flow from the generator 82 may be increased causing the generator 82 to develop more input torque. The increased torque will result in slower rotation of the turbine 80 causing more energy to be extracted from the bleed air before exiting from an outlet 74 of the turbo-generator 66.

With reference again to FIG. 3, in embodiments of the bleed air system 60 having one or more ports 62 for extracting high pressure air from the engine 20, the energy of the bleed air provided to the system 60 will always exceeds the energy demands of the one or more aircraft systems 58, 59 located downstream therefrom. Accordingly, during operation of the bleed air system 60, the turbo-generator 66 will always extract at least some energy the bleed air provided thereto while reducing the pressure and/or the temperature of the bleed air. In an embodiment, the turbo-generator 66 is configured to reduce the temperature of the bleed air to less than 450° F. and reduce the pressure of the bleed air to less than 50 psia.

The amount of energy extracted from the bleed air drawn from port 62 will vary based on the demands of the aircraft system 58, 59. For example, when the aircraft is cruising, the energy demands of the aircraft systems 58, 59 are generally low. As a result, a substantial amount of energy may be extracted from the high pressure bleed air and converted into electrical energy to be supplied to the electrical loads of the aircraft 10. However, when the aircraft engines 20 are idling, such as during descent or when the aircraft 10 is on the ground for example, the energy demands of the aircraft systems 58, 59 increase. Because the energy of the high pressure air drawn from the port 62 exceeds these increased demands of the aircraft systems 58, 59, the turbo-generator 66 will still extract energy from the bleed air. However, the amount of energy extracted from the bleed air when the engines 20 are idling will be less than when the engines 20 are creating thrust, such as during cruise for example.

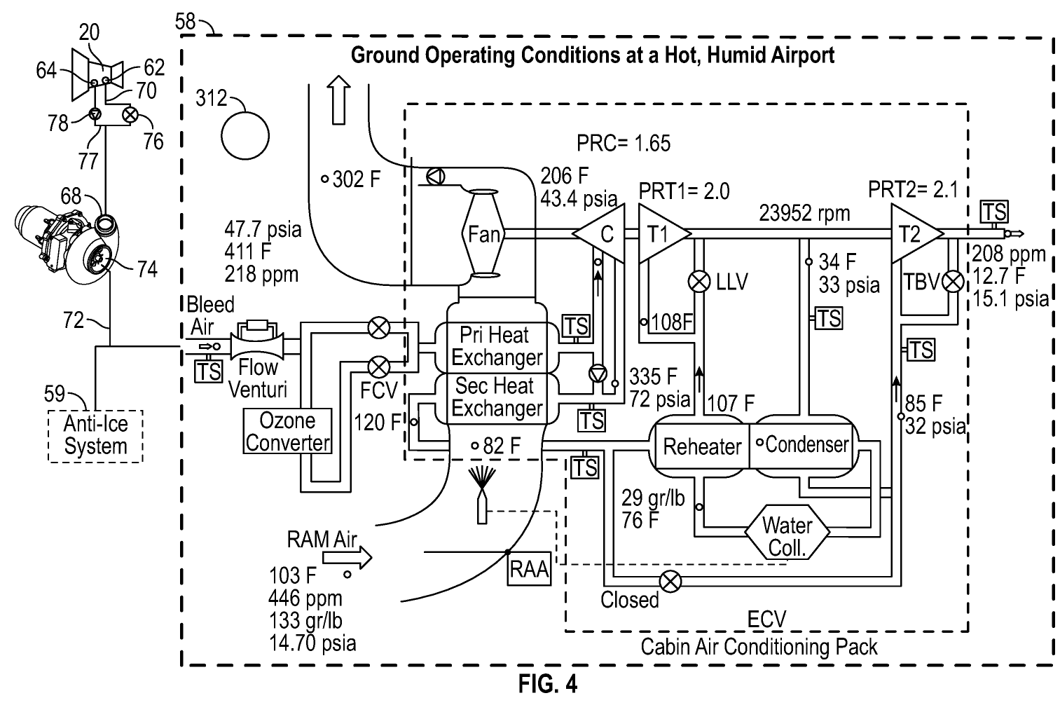

With reference now to FIG. 4, in another embodiment the bleed air system 60 includes one or more first ports 62 configured to bleed high pressure air and one or more second ports 64 configured to draw low pressure air from the engine 20. The bleed air extracted from the low pressure port 64 may have a maximum temperature of about 800° F. and a maximum pressure of about 150 psia. The first port 62 may bleed air from a portion of the high pressure spool 32, such as the high pressure compressor 52 for example, and the second port 64 may bleed air from a portion of the low pressure spool 30, such as the low pressure compressor 44 for example. However, it should be understood that the indication of “low pressure” and “high pressure” with respect to the ports is a relative term indicating that the high pressure port is at a location of higher pressure than the location of the low pressure port. Accordingly, the first port 62 and the second port 64 may be located at other positions relative to the engine.

In embodiments where the bleed air system 60 includes a first port 62 for drawing relatively high pressure air and a second port 64 for drawing relatively low pressure air, as shown in FIG. 4, a valve 76 may be located within the bleed passage 70 extending between the first port 62 and the inlet of the turbo-generator 66. A second bleed passage 77 fluidly couples the second port 64 to the turbo-generator inlet 68. In an embodiment, the second bleed passage 77 is connected to the first bleed passage 70 upstream from the inlet 68. In such embodiments, a one way check valve 78 may be located along the second bleed passage 70 between the second port 64 and the inlet 68 to prevent the flow of bleed air from the first port 62 back to the engine 20 via the second port 64.

Depending on the demands of the aircraft 10, bleed air is selectively drawn from one of the first port 62 and the second port 64 and provided to the turbo-generator 66. In most flight situations, the demands of the aircraft systems 58, 59 are low and therefore low pressure air is drawn from the second port 64. Because the energy of the air from port 64 exceeds the energy demand of the aircraft systems 58, 59, electrical energy is created as the air passes through the turbo-generator 66. In flight situations where the engine 20 is in a low throttle state, such as during ground maneuvers for example, the bleed air from the low pressure port 64 does not provide enough energy to meet the demands of the aircraft systems 58, 59. In such situations, the valve 76 is operated and high pressure air drawn from the first port 62 is provided to the turbo-generator 66. Excess energy is extracted from the high pressure air before it is provided to one or more of the aircraft systems 58, 59. Within the turbo-generator 66, the excess energy extracted from both the low pressure air and the high pressure air is converted to electricity which may be supplied to the electrical demands of the aircraft 10.

The bleed air system 60 illustrated and described herein eliminates the need for bleed air hardware including valves and a pre-cooler, thereby increasing the reliability of the bleed air system. Further, by capturing excess energy of the bleed air, the bleed air system 60 which further increases the fuel efficiency of the aircraft.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Also, in the drawings and the description, there have been disclosed embodiments of the invention and, although specific terms may have been employed, they are unless otherwise stated used in a generic and descriptive sense only and not for purposes of limitation, the scope of the invention therefore not being so limited. Moreover, the use of the terms first, second, etc., do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An engine bleed air system providing air to an aircraft system, comprising:
a port for extracting high pressure bleed air from an engine; and
a turbo-generator having a turbine and a generator, the generator being driven by rotation of the turbine;
a bleed passage fluidly coupling the port and an inlet of the turbo-generator; and
an outlet passage fluidly coupling an outlet of the turbo-generator and the aircraft system.

2. The system of claim 1, wherein the port is configured to bleed air from a high pressure compressor of a high pressure spool of the engine.

3. The system of claim 1, wherein the turbo-generator is configured to reduce at least one of a pressure and temperature of the bleed air.

4. The system of claim 1, wherein the turbo-generator extracts energy from the bleed air and converts it into electrical energy via the generator.

5. The system of claim 4, wherein an amount of energy extracted from the bleed air varies based on a demand of the aircraft system.

6. The system of claim 1, wherein the aircraft system includes one or more of an environmental control system and an anti-icing system.

7. The system of claim 1, further comprising:
another port for extracting low pressure bleed air from the engine; and
another bleed passage fluidly coupling the another port and the inlet of the turbo-generator.

8. The system of claim 7, wherein the another port is configured to bleed air from a low pressure compressor of a low pressure spool of the engine.

9. The system of claim 7, further comprising a valve located within the bleed passage between the port and the inlet of the turbo-generator, the valve being operable to control a flow of air from the port and the another port to the inlet.

10. The system of claim 9, further comprising a one way check valve positioned within the another bleed passage downstream from the another port but upstream from an interface between the bleed passage and the another bleed passage.

11. The system of claim 7, wherein bleed air from the another port is selectively provided to the turbo-generator when an energy of the bleed air from the another port exceeds a demand of the aircraft system.

12. The system of claim 11, wherein bleed air from the port is provided to the turbo-generator when an energy of the bleed air from the another port is less than the demand of the aircraft system and an energy of the bleed air from the port exceeds the demand of the aircraft system.

13. A method of operating a bleed air system of an aircraft comprising:
drawing bleed air from an engine;
extracting energy from the bleed air in a turbo-generator; and
providing the bleed air to an aircraft system.

14. The method of claim 13, further comprising reducing a pressure of the bleed air within the turbo-generator.

15. The method of claim 13, further comprising reducing a temperature of the bleed air within the turbo-generator.

16. The method of claim 13 further comprising:
determining a demand of one or more aircraft systems;
drawing bleed air from a first port if an energy of the bleed air at the first port is greater than the demand of the one or more aircraft systems; and
drawing bleed air from a second port if the energy of the bleed air at the first port is less than the demand of the one or more aircraft systems and if an energy of the bleed air at the second port is the greater than the demand of the one or more aircraft systems.

17. The method of claim 13 further comprising operating a valve to selectively draw bleed air from one of the first port and the second port.
